(19) United States
(12) Patent Application Publication
(10) Pub. No.: US 2007/0199502 A1
(43) Pub. Date: Aug. 30, 2007

(54) Inflatable buoy assembly for drivers

(76) Inventor: Jerry Bifulco, Port St. Lucie, FL (US)

Correspondence Address: Oltman, Flynn & Kubler, Ste. #415, 915 Middle River Drive, Fort Lauderdale, FL, 33304, US

(21) Appl. No.: 11/362,576

(22) Filed: Feb. 27, 2006

(51) Int. Cl. B64B 1/40

(52) U.S. Cl. 116/210

(57) ABSTRACT

An inflatable buoy assembly for use with diving equipment includes a scuba tank, a first stage regulator, a first stage regulator hose and a buoyancy compensator, the assembly including a buoy including a balloon attached to and in fluid communication with a balloon mounting vessel; and an air valve adaptor in fluid communication with the first stage regulator and the buoyancy compensator and having an air fill chuck valve for direct connection to the buoy; so that the balloon is deflated while the assembly is carried and stored, and when the buoy is needed, air is delivered into the mounting vessel from the buoyancy compensator to inflate the balloon.

### BACKGROUND OF THE INVENTION

1. Field of the Invention

The present invention relates generally to the field of diving equipment. More specifically the present invention relates to an inflatable buoy assembly for use by divers to indicate to people above water an underwater object location, the diver location or an emergency or to lift objects.

The buoy assembly includes a buoy with a balloon attached to a balloon mounting vessel and an air valve adaptor with an air fill chuck valve for direct connection to the buoy. The air fill chuck valve preferably is a tire fill valve. The balloon is deflated while the assembly is carried and stored. Then, when the buoy is needed, air is delivered into the mounting vessel from the scuba tank to the buoyancy compensator quick connect hose to inflate the balloon.

The balloon has a balloon neck leading to a balloon opening and the balloon mounting vessel has a vessel opening to which the balloon opening is sealingly mounted so that the balloon is in fluid communication with the interior of the mounting vessel. The balloon preferably and has external threads around the balloon neck adjacent the balloon opening which engagingly screw into internal threads in the vessel side wall encircling the vessel opening. The balloon preferably is either a household party balloon or a reinforced vinyl balloon.

The air valve adaptor preferably includes T-shaped conduit having a T-cross segment with a female quick connect coupler at one cross-segment end for connection to the buoyancy compensator and a male quick connect coupler structure at the other cross-segment end for connection to the first stage regulator hose, and having a T-lateral segment containing an air fill chuck valve, and includes a universal air inflation valve for releasible sealed connection to the air fill chuck valve to deliver air from the buoyancy compensator through the mounting vessel and into the balloon.

Alternatively the air valve adaptor has an internal thread at one T-cross segment end for connection to the first stage regulator hose and has an external thread at the other cross-segment end for connection to a buoyancy compensator port. The universal air inflation check valve preferably is an air chuck. For another variation the universal air inflation valve is an air chuck and the air fill chuck valve is an air chuck fill valve.

Additional preferred elements include safety check valve to release excess pressure, a stainless steel rope ring fitted to the mounting vessel to which a rope line can be secured. A light emitting diode (LED) may be provided within the balloon to illuminate the balloon and thereby help attract attention, especially at night, and is connected to a power circuit including a battery within the vessel.

2. Description of the Prior Art

There have long been inflatable buoy and signal balloon devices, some for use underwater and some for use in the atmosphere. Bags and balloons of underwater devices which are inflated by exhaled air from the diver or from his regulator mouthpiece have required the diver to remove the mouthpiece from his mouth and hold his breath. These bags and balloons generally remain open at their lower ends and thus cannot be permitted to float above the water line because they would deflate immediately. They are also inflated from separate compressed gas cylinders provided with the device which make the device more bulky to carry.

Casciano, U.S. Pat. No. 3,760,440, issued on Sep. 25, 1973, discloses a diver signal and/or marker with colored air bags which are floated to the surface to indicate conditions below or to mark a location. Casciano includes a packet containing at least one tube which in turn contains a capsule retaining a compressed bag and has a bottom wall with an opening so that the diver can blow air into the bag.

Van Wyck, U.S. Pat. No. 5,520,486, issued on May 28, 1996, teaches a diver safety apparatus. Van Wyck describes a relatively bulky apparatus including a housing, a cap releasibly attached to the housing and sealing means for sealing an inflatable tube and compressed gas cylinder for tube inflation, a siren and a power supply. The tube inflates to a doughnut shape around the housing.

Lutz, U.S. Pat. No. 3,735,723, issued on May 29, 1973, discloses an inflatable emergency device. Lutz is similar to Van Wyck in that it includes a relatively bulky housing and a compressed air cylinder.

Shieh, U.S. Pat. No. 5,839,931, issued on Nov. 24, 1998, reveals a safety stop anchor. Shieh includes an oval or spherical bag having a bottom opening serving as a gas inlet. Several through holes are provided adjacent the bottom opening through which a string is threaded to hold a weight. The buoy cannot become over-swollen and burst, as stated in the middle of column 4, because extra air can escape through the bottom opening.

Schmidt, U.K. Patent Application Number GB 2039120 A, published Jul. 30, 1980, teaches a position indicating marker device. Schmidt includes a balloon which may be filled with lighter-than-air gas, and appears to be intended for use in the atmosphere only.

It is thus an object of the present invention to provide an inflatable buoy for divers which includes a conventional balloon which can be inflated through a chuck valve from a scuba tank to the buoyancy compensator adaptor, and thus remain securely inflated to float above the water line and thus be visible under almost all conditions, without disabling the buoyancy compensator and without interrupting the delivery of air to the diver, and which cannot accidentally inflate.

It is another object of the present invention to provide such an inflatable buoy from which a worn or damaged balloon or other part can be easily removed and replaced, and which has very few moving parts which could be damaged by salt or fresh water.

It is still another object of the present invention to provide such an inflatable buoy which includes light and sound emission means to attract attention more effectively and transmitter means such as GPS to indicate location.

It is finally an object of the present invention to provide such an inflatable buoy which is safe to use, easy accessible because it is always connected to dive equipment, reliable, durable, compact to carry and relative inexpensive to manufacture.

### SUMMARY OF THE INVENTION

The present invention accomplishes the above-stated objectives, as well as others, as may be determined by a fair reading and interpretation of the entire specification.

An inflatable buoy assembly is provided for use with diving equipment including a scuba tank, a first stage regulator, a first stage regulator hose and a buoyancy compensator quick connect hose, the assembly including a buoy including a balloon attached to and in fluid communication with a balloon mounting vessel; and an air valve adaptor in fluid communication with the first stage regulator and having an air fill chuck valve for direct connection to the buoy; so that the balloon is deflated while the assembly is carried and stored, and when the buoy is needed, air is delivered into the mounting vessel from the scuba tank to inflate the balloon.

The air valve adaptor preferably includes a T-shaped conduit having a T-cross segment with a female quick connect coupler at a first T-cross-segment end for connection to a male quick connect coupler structure at a second T-cross-segment end for connection to the first stage regulator hose; having a T-lateral segment containing an air fill chuck valve; and a universal air inflation valve for releasible sealing connection to the air fill chuck valve to deliver air from the buoyancy compensator through the mounting vessel and into the balloon.

An inflatable buoy assembly is further provided for use with diving equipment including a first stage regulator and a scuba tank, the assembly including a buoy including a balloon attached to and in fluid communication with a balloon mounting vessel having an interior, the balloon having a balloon neck leading to a balloon opening, the mounting vessel having a vessel opening to which the balloon opening is sealingly mounted so that the balloon is in fluid communication with the interior of the mounting vessel; and an air valve adaptor in fluid communication with the first stage regulator and having an air fill chuck valve for direct connection to the buoy; so that the balloon is deflated while the assembly is carried and stored, and when the buoy is needed, air is delivered into the mounting vessel from the scuba tank to inflate the balloon.

The air fill chuck valve preferably is a tire fill valve. The balloon has external threads around the balloon neck adjacent the balloon opening which engagingly screw into internal threads in the vessel side wall encircling the vessel opening. The balloon preferably is one of a household party balloon and a reinforced vinyl balloon.

The air valve adaptor preferably includes a T-shaped conduit having a T-cross segment with a female quick connect coupler at a first T-cross-segment end for connection to the buoyancy compensator and a male quick connect coupler structure at a second T-cross-segment end for connection to the first stage regulator hose, and having a T-lateral segment containing an air fill chuck valve, and includes a universal air inflation valve for releasible sealing connection to the air fill chuck valve to deliver air from the buoyancy compensator through the mounting vessel and into the balloon. The air valve adaptor preferably has an internal thread at a first T-cross segment end for connection to the first stage regulator hose and has an external thread at a second cross-segment end for connection to a regulator port. The air fill chuck valve preferably includes an air chuck. The universal air inflation valve preferably includes an air chuck. The inflatable buoy assembly preferably additionally includes a safety check valve for releasing excess pressure. The inflatable buoy assembly preferably additionally includes a rope ring fitted to the mounting vessel and a rope line secured to the rope ring. The inflatable buoy assembly preferably additionally includes a light emitting diode secured to the mounting vessel for attracting attention to the buoy; and a power circuit connected to the light emitting diode including a battery.

A diving apparatus is provided including diving equipment including a scuba tank, a first stage regulator, a first stage regulator hose and a buoyancy compensator; an inflatable buoy assembly including a buoy including a balloon attached to and in fluid communication with a balloon mounting vessel having an interior and a buoy valve port, the balloon having a balloon neck leading to a balloon opening, the mounting vessel having a vessel opening to which the balloon opening is sealingly mounted so that the balloon is in fluid communication with the interior of the mounting vessel; and an air valve adaptor in fluid communication with the first stage regulator and the buoyancy compensator and having an air fill chuck valve for direct connection to the buoy valve port; so that the balloon is deflated while the assembly is carried and stored, and when the buoy is needed, air is delivered into the mounting vessel from the buoyancy compensator to inflate the balloon.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a perspective view of the balloon mounting vessel with a portion of the vessel side wall broken away to reveal the optional line spool and of balloon in its deflated mode positioned for interconnection to form the buoy, with the rope ring and rope.

FIG. 2 is a perspective view of the assembled buoy with the balloon in its inflated mode.

FIG. 3 is a side view of the air valve adaptor secured sealingly between part of a buoyancy compensator and a broken away segment of the regulator hose.

FIG. 4 is a side view of the first embodiment of the air valve adaptor.

FIG. 5 is a side view of the second embodiment of the air valve adaptor.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

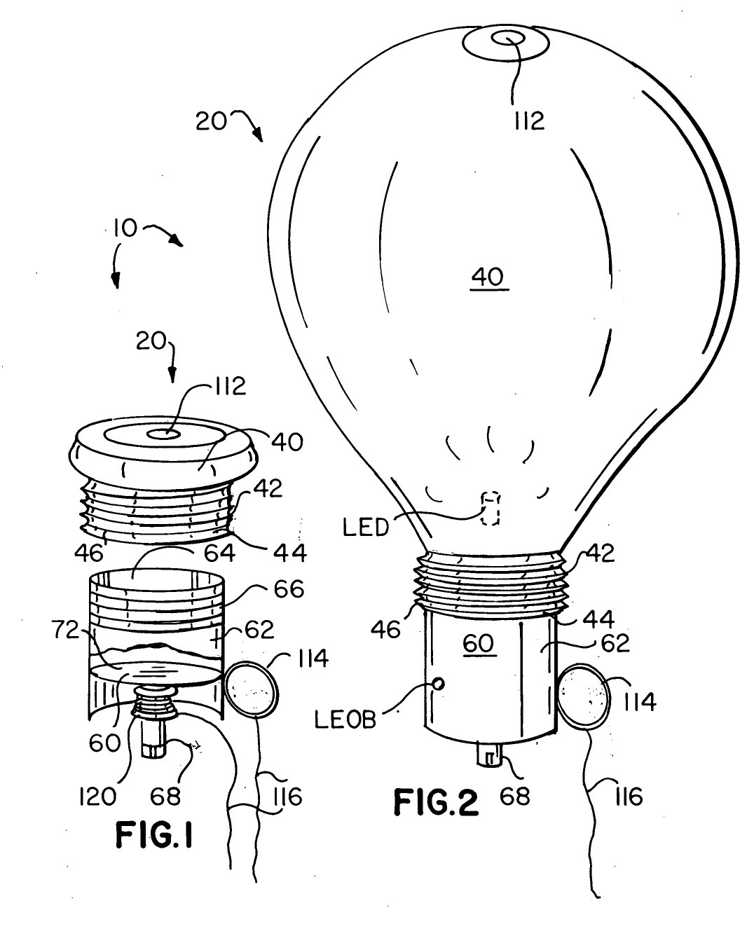

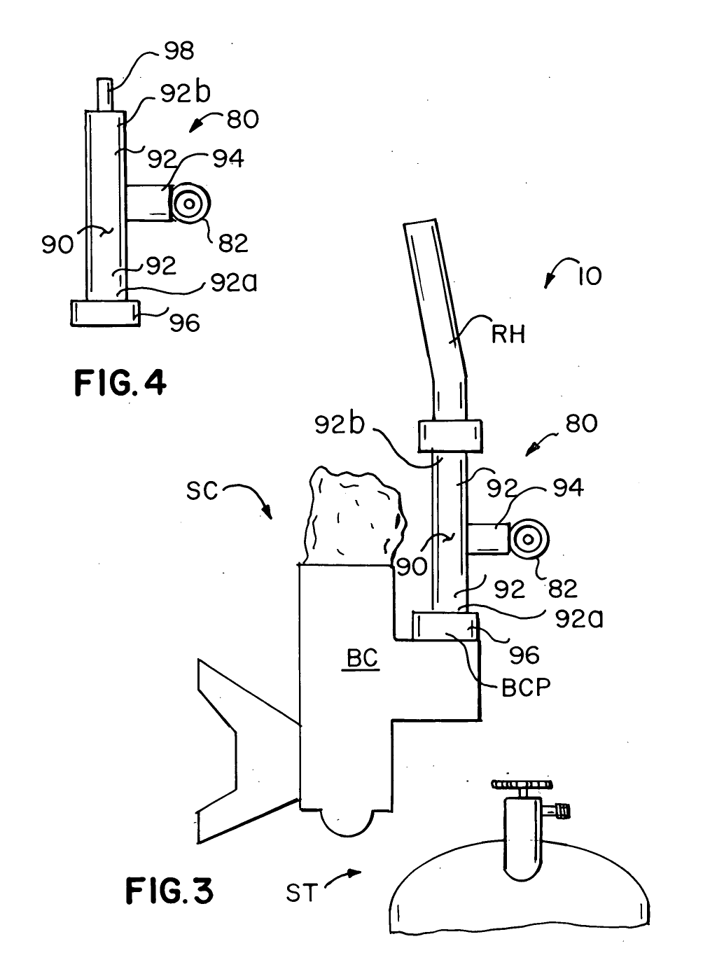

Referring to FIGS. 1-4, an inflatable buoy assembly 10 is disclosed for use by divers including a buoy 20 in the form of a balloon 40 attached to a balloon mounting vessel 60 with an air fill chuck valve 68 and including an air valve adaptor 80 with an air inflation valve 82 for incorporation into the diver scuba assembly SC and for direct connection to the buoy 20. The air fill chuck valve 68 preferably is a tire fill valve called an air chuck fill valve. The balloon 40 is deflated while the assembly 10 is carried and stored. Then, when the buoy 20 is needed, air is delivered into the mounting vessel 60 from the scuba tank ST through the air valve adaptor 80 and into the buoy 20 to inflate the balloon 40.

The balloon 40 has a balloon neck 42 leading to a balloon opening 44 and the balloon mounting vessel 60 has a vessel opening 64 to which the balloon opening 44 is sealingly mounted so that the balloon 40 is in fluid communication with the interior of the mounting vessel 60. The balloon 40 preferably and has balloon external threads 46 around the balloon neck 42 adjacent the balloon opening 44 which engagingly screw into internal vessel threads 66 in the vessel side wall 62 encircling the vessel opening 64. The balloon 40 preferably is either a household party balloon or a reinforced vinyl balloon.

The air valve adaptor 80 preferably includes T-shaped conduit 90 having a T-cross segment 92 with a female quick connect coupler 96 at a first T-cross-segment end 92a for connection to the buoyancy compensator BC and a male quick connect coupler structure 98 at a second T-cross segment end 92b for connection to the first stage regulator hose RH, and having a T-lateral segment 94 containing a universal air inflation valve 82 for releasible sealing connection to the air fill chuck valve 68 to deliver air from the buoyancy compensator BC through the mounting vessel 60 and into balloon 40.

### Second Preferred Embodiment

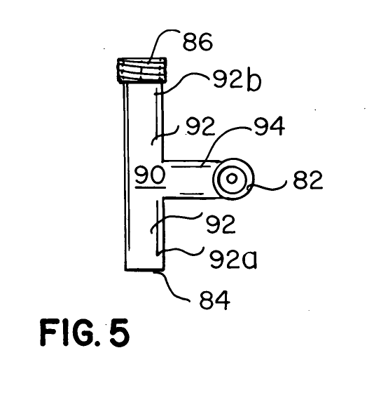

Alternatively the air valve adaptor 80 has an internal thread 84 at the first T-cross segment end 92a for connection to the first stage regulator hose RH and has an external thread 86 at the second and T-cross-segment end 92b for connection to a regulator compensator port (not shown). See FIG. 5. The universal air inflation valve 82 preferably is an air chuck. For another variation the universal air inflation valve 82 is an air chuck and the air fill chuck valve 68 is the air fill chuck valve.

Additional preferred elements include safety check valve 112 to release excess pressure, a stainless steel rope ring 114 fitted to the mounting vessel 60 to which a rope line 116 can be secured. The rope line 116 alternatively can be mounted on a spool 120 rotatably mounted around the air fill chuck valve 68, preferably where the vessel bottom wall 72 is recessed into the vessel side wall 62. See FIG. 1. A light emitting diode LED may be provided within the balloon 40 to illuminate the balloon 40 and thus to help attract attention, especially at night, and is connected to a power circuit (not shown) including an LED activation button switch LEDB including a battery within the mounting vessel 60.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. An inflatable buoy assembly for use with diving equipment including a scuba tank, a first stage regulator, a first stage regulator hose and a buoyancy compensator quick connect hose, comprising:
a buoy comprising a balloon attached to and in fluid communication with a balloon mounting vessel;
and an air valve adaptor in fluid communication with the first stage regulator and having an air fill chuck valve for direct connection to said buoy;
such that said balloon is deflated while said assembly is carried and stored, and when said buoy is needed, air is delivered into said mounting vessel from the scuba tank to inflate said balloon.

2. The inflatable buoy assembly of claim 1, wherein said air valve adaptor comprises a T-shaped conduit having a T-cross segment with a female quick connect coupler at a first T-cross-segment end for connection to a male quick connect coupler structure at a second T-cross-segment end for connection to the first stage regulator hose;
having a T-lateral segment containing an air fill chuck valve;
and a universal air inflation valve for releasible sealing connection to said air fill chuck valve to deliver air from the scuba tank through said the mounting vessel and into said balloon.

3. An inflatable buoy assembly for use with diving equipment including a first stage regulator and a scuba tank, comprising:
a buoy comprising a balloon attached to and in fluid communication with a balloon mounting vessel having an interior, said balloon having a balloon neck leading to a balloon opening, said mounting vessel having a vessel opening to which said balloon opening is sealingly mounted such that said balloon is in fluid communication with the interior of said mounting vessel;
and an air valve adaptor in fluid communication with the first stage regulator and having an air fill chuck valve for direct connection to said buoy;
such that said balloon is deflated while said assembly is carried and stored, and when said buoy is needed, air is delivered into said mounting vessel from the scuba tank to inflate said balloon.

4. The inflatable buoy assembly of claim 3, wherein said air fill chuck valve is a tire fill valve.

5. The inflatable buoy assembly of claim 3, wherein said balloon has external threads around said balloon neck adjacent said balloon opening which engagingly screw into internal threads in said vessel side wall encircling said vessel opening.

6. The inflatable buoy assembly of claim 3, wherein said balloon is one of a household party balloon and a reinforced vinyl balloon.

7. The inflatable buoy assembly of claim 3, wherein said air valve adaptor comprises a T-shaped conduit having a T-cross segment with a female quick connect coupler at a first T-cross-segment end for connection to a buoyancy compensator and a male quick connect coupler structure at a second T-cross-segment end for connection to the first stage regulator hose, and having a T-lateral segment containing an air fill chuck valve, and comprises a universal air inflation valve for releasible sealing connection to said air fill chuck valve to deliver air from the buoyancy compensator through said mounting vessel and into said balloon.

8. The inflatable buoy assembly of claim 3, wherein said air valve adaptor has an internal thread at a first T-cross segment end for connection to the first stage regulator hose and has an external thread at a second cross-segment end for connection to a regulator port.

9. The inflatable buoy assembly of claim 3, wherein said air fill chuck valve comprises an air chuck.

10. The inflatable buoy assembly of claim 3, wherein said universal air inflation valve comprises an air chuck.

11. The inflatable buoy assembly of claim 3, additionally comprising a safety check valve for releasing excess pressure.

12. The inflatable buoy assembly of claim 3, additionally comprising a rope ring fitted to said mounting vessel and a rope line secured to said rope ring.

13. The inflatable buoy assembly of claim 3, additionally comprising:
a light emitting diode secured to said mounting vessel for attracting attention to said buoy;
and a power circuit connected to said light emitting diode comprising a battery.

14. A diving apparatus comprising:
diving equipment comprising a scuba tank, a first stage regulator, a first stage regulator hose and a buoyancy compensator;
an inflatable buoy assembly comprising a buoy including a balloon attached to and in fluid communication with a balloon mounting vessel having an interior and a buoy valve port, said balloon having a balloon neck leading to a balloon opening, said mounting vessel having a vessel opening to which said balloon opening is sealingly mounted such that said balloon is in fluid communication with the interior of said mounting vessel; and an air valve adaptor in fluid communication with said first stage regulator and said buoyancy compensator and having an air fill chuck valve for direct connection to said buoy valve port;
such that said balloon is deflated while said assembly is carried and stored, and when said buoy is needed, air is delivered into said mounting vessel from the buoyancy compensator to inflate said balloon.
